(19) United States
(12) Patent Application Publication
(10) Pub. No.: US 2016/0116643 A1
(43) Pub. Date: Apr. 28, 2016

(54) ANTI-SCATTERING FILM WITH EXCELLENT OPTICAL AND SCRATCH-RESISTANT PROPERTIES AND METHOD FOR MANUFACTURING SAME

(71) Applicant: LG Hausys, Ltd., Seoul (KR)

(72) Inventors: Joo Hee HONG, Uiwang-si, Gyeonggi-do (KR); Won Kook KIM, Daejeon (KR)

(21) Appl. No.: 14/771,799

(22) PCT Filed: Dec. 24, 2013
(86) PCT No.: PCT/KR2013/012109

§ 371 Date: Dec. 10, 2015

(30) Foreign Application Priority Data
Mar. 7, 2013 (KR) 10-2013-0024477

(51) Int. Cl. G02B 1/14; C09J 7/02; C09D 133/08

(52) U.S. Cl. CPC G02B 1/14; C09D 133/08; C09J 7/0264; C08K 5/23

(57) ABSTRACT

Disclosed are an anti-scattering film with excellent optical and scratch-resistant properties and a method for manufacturing the same. The anti-scattering film according to the present invention comprises: a transparent film; and a hard coating layer formed on the top of the transparent film, wherein the hard coating layer comprises 1-30 parts by weight of inorganic nanoparticles, 1-70 parts by weight of a UV-curable acrylate resin, 1-15 parts by weight of a photo-initiator, and 0.2-5 parts by weight of azo-based dyes, with respect to 100 parts by weight of solids.

### FIELD OF THE DISCLOSURE

The present disclosure relates to an anti-scattering film, and more particularly to an anti-scattering film with excellent optical and scratch resistant properties, and a method for manufacturing the same.

### BACKGROUND OF THE DISCLOSURE

Structure of touch screen panel applied to, for example, mobile phone is in a trend that is converted from a conventional multi-layer structure into an integrated structure. This integrated structure of touch screen panel at least results from not requiring using a high cost transparent electrode (ITO) film.

The integrated structure of touch screen panel allows slimmer products and more improved visible light transmittance. In spite of these advantages, problems that a cover glass for a display surface is broken by a drop impact frequently occur.

Accordingly, in order to enhance the stability of the debris formed after the glass breakage in such a portable device, the scattering of the cover glass may be prevented by insertion of an anti-scattering film between the panel and the cover glass.

The anti-scattering film generally includes a structure of hard coating layer/substrate/adhesive layer, whereby the hard coating layer per se requires optical and scratch resistant properties.

For the conventional anti-scattering film, efforts were made for the improvement in hardness using a coating solution comprising high functionality acrylate resins. However, a part of the hard coating layer had a high haze value and a high yellow index value, and generated a curling, and thus the optical properties were poor. Further, a high contact angle of the hard coating layer might cause delamination problem with a subsequent coating layer.

In the related prior art, Korea Laid-open Patent Publication No. 2012-0069307 (publication date: Jun. 28, 2012) discloses a glass scattering protecting film with excellent optical and electrical properties, comprising an adhesive layer comprising an acid-free type of hydroxyl containing adhesive.

### SUMMARY OF THE DISCLOSURE

In one object of the disclosure, an anti-scattering film with excellent optical and scratch resistant properties is provided.

In another object of the disclosure, an anti-scattering film capable of inhibiting a delamination of a subsequent coating layer is provided.

In another object of the disclosure, a method suitable for manufacturing the above-described anti-scattering film is provided.

In order to accomplish the above object, an anti-scattering film in accordance with one aspect of the disclosure comprises a transparent film, and a hard coating layer formed on a upper surface of the transparent film, wherein the hard coating layer includes 1-30 parts by weight of inorganic nanoparticles, 1-70 parts by weight of a UV-curable acrylate resin, 1-15 parts by weight of a photo-initiator, and 0.2-5 parts by weight of azo-based dyes, with respect to 100 parts by weight of solids.

Further, in order to accomplish the other object, a method for manufacturing an anti-scattering film in accordance with another aspect of the disclosure comprises applying, drying and curing a hard coating solution onto a surface of a transparent film to form a hard coating layer, wherein the hard coating layer includes 1-30 parts by weight of inorganic nanoparticles, 1-70 parts by weight of a UV-curable acrylate resin, 1-15 parts by weight of a photo-initiator, and 0.2-5 parts by weight of azo-based dyes, with respect to 100 parts by weight of solids.

The anti-scattering film according to the present disclosure where the hard coating layer includes inorganic nanoparticles, a UV-curable acrylate resin, and azo-based dyes can provide excellent optical and scratch resistant properties.

In addition, the anti-scattering film according to the present disclosure can prevent a delamination with a subsequent coating layer by the formation of a hard coating layer whose contact angle is less than or equal to 70 degrees.

According to the present disclosure, controlling a composition of the hard coating layer may contribute to make an anti-scattering film with excellent optical and scratch resistant properties while at the same time having low delamination property with a subsequent coating layer with easy.

In addition, according to the present disclosure, it is possible to improve a blanking problem during process by the above-described anti-scattering film and accordingly enhance process yield.

### BRIEF DESCRIPTION OF THE DRAWINGS

FIG. 1 schematically shows an anti-scattering film according to an exemplary embodiment of the present disclosure.

FIG. 2 schematically shows a diagram illustrating a method for manufacturing an anti-scattering film according to an exemplary embodiment of the present disclosure.

FIG. 3 schematically shows a diagram illustrating a method for manufacturing an anti-scattering film according to another embodiment of the present disclosure.

FIG. 4 shows a photograph of measuring a contact angle on a surface of a hard coating layer in an anti-scattering film according to Example 1 of the present disclosure.

### DETAILED DESCRIPTION OF THE EMBODIMENTS

The present disclosure and methods of accomplishing the same may be understood more readily by reference to the following detailed description of embodiments and the accompanying drawings. However, the present disclosure may be embodied in many different forms, and should not be construed as being limited to the embodiments set forth herein. Rather, these embodiments are provided so that this disclosure will be thorough and complete and will fully covey the concept of the invention to those skilled in the art, and the present disclosure will only be defined by the appended claims. Like reference numerals designate like elements throughout the specification.

In the following detailed description, only certain exemplary embodiments of an anti-scattering film with excellent optical and scratch resistant properties, and a method for manufacturing the same according to the present disclosure have been shown and described, simply by way of illustration, with reference to the accompanying drawings.

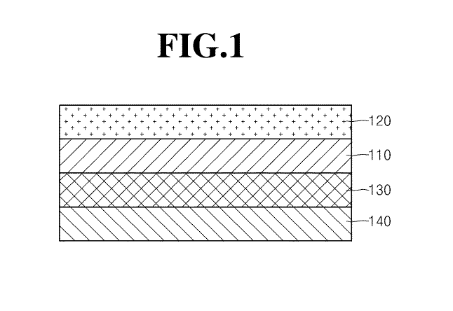

FIG. 1 is a schematic cross-sectional view showing an anti-scattering film according to an exemplary embodiment of the present disclosure.

Referring to FIG. 1, the anti-scattering film according to an exemplary embodiment of the present disclosure may include a transparent film 110 and a hard coating layer 120 on a upper surface of the transparent film 110, and it may further include an adhesive layer 130 and a release film 140, sequentially, from an opposite surface of the transparent film 110.

The transparent film 110 may have excellent strength to prevent the scattering of a glass, such as a reinforced glass in touch screen panel, as well as have excellent transparency with a visible light transmittance of at least 90%, and preferably 90 to 100% enough not to hinder the optical properties.

The transparent film 110 may include at least one selected from the group consisting of polyethylene terephthalate (PET), polyethylene naphthalate (PEN), polyether sulfone (PES), polycarbonate (PC), polyethylene (PE), and polypropylene (PP). More preferably, PET film having a visible light transmittance of 92% may be included.

In some embodiments of the disclosure, a hard coating composition having a pencil hardness after curing of at least 2H, more preferably 2H to 9H, may be used for the hard coating layer 120 to improve the hardness of the transparent film 110. Further, in some embodiments of the disclosure, a hard coating composition having a transmittance after curing of at least 90%, preferably 90 to 100%, a haze value of 0.8 or less, and a yellow index value of 0.8 or less may be used for the hard coating layer 120 to improve the optical properties of the transparent film 110.

For an existing anti-scattering film, a coating solution comprising high functionality acrylate resins has been used for the hard coating layer to improve the hardness. However, some of the hard coating layer had a high haze value and a high yellow index value, and generated a curling, and thus the optical properties were poor.

However, as a result of forming the hard coating layer 120 having the following composition according to the present disclosure, the optical and scratch resistant properties can be ensured.

The hard coating layer 120 according to some embodiments of the disclosure may include 1-30 parts by weight of inorganic nanoparticles, 1-70 parts by weight of a UV-curable acrylate resin, 1-15 parts by weight of a photo-initiator, and 0.2-5 parts by weight of azo-based dyes, with respect to 100 parts by weight of solids.

The inorganic nanoparticles will contribute to improved hardness. In some embodiments of the disclosure, the inorganic nanoparticles are preferably added in an amount of 1 to 30 parts by weight with respect to 100 parts by weight of solids. If the quantity of the inorganic nanoparticles is added less than 1 part by weight, the addition effect may be insufficient, whereas if the quantity exceeds 30 parts by weight, it may cause increases in the haze value and the yellow index value, thereby deteriorating the optical properties.

The UV-curable acrylate resin may include at least two or more, preferably 2 to 15 functional groups which contribute to increased hardness and curling protection. In this case, if the number of the functional groups contained in the UV-curable acrylate resin is less than 2, the addition effect may be insufficient, whereas if the number of the functional groups is more than 15, it may result in the occurrence of undesired curling.

In some embodiments of the disclosure, the UV-curable acrylate resin is preferably added in an amount of 1 to 70 parts by weight with respect to 100 parts by weight of solids. If the quantity of the UV-curing acrylate resin is less than 1 part by weight, the addition effect may be insufficient, whereas if it exceeds 70 parts by weight, desired functionality of the coating solution may not be effective.

The photo-initiator is excited by ultraviolet rays and serves to initiate photo-polymerization. In some embodiments of the disclosure, the photo-initiator is preferably included in an amount of from 1 to 15 parts by weight with respect to 100 parts by weight of solids. If the content of the photo-initiator is added less than 1 part by weight, curing reaction time may be longer. In contrast, if it exceeds 15 parts by weight, unreacted photo-initiator may remain in its impurities.

The photo-initiator may include, but is not limited to, known photo-initiators, such as benzophenone.

The azo-based dyes may be introduced in the present disclosure to lower the yellow index value which is in a complementary relation with blue. As used herein, the azo-based dye refers to a dye having an azo group —N═N— as a chromophore in the molecule. The azo-based dye may be dissolved in an organic solvent.

In some embodiments of the disclosure, the azo-based dyes are preferably included in an amount of from 0.2 to 5 parts by weight with respect to 100 parts by weight of solids. In this case, if the content of the azo-based dye is less than 0.2 part by weight, the addition effect may be insufficient. In contrast, if the content of the azo-based dyes exceeds 5 parts by weight, it may cause an increased haze value, thereby rather deteriorating the optical properties.

The hard coating layer 120 has preferably a thickness of 1 μm-10 μm, more preferably of 3 μm-5 μm. If the hard coating layer 120 is formed to a thickness of less than 1 μm, it is difficult to obtain sufficient hard coating effects. Further, if the hard coating layer 120 exceeds a thickness of 10 μm, it may increase the cost for hard coating.

For a conventional anti-scattering film, due to high contact angle of hard coating layer, delamination problem with a subsequent coating layer occurs.

In order to prevent this problem, it is preferred that the contact angle on a surface of the hard coating layer 120 is formed in a range of less than or equal to 70 degrees, i.e., greater than 0 degree to less than or equal to 70 degrees. The contact angle of the hard coating layer 120 is dependent on a composition of the hard coating layer 120, and may vary within the above ranges where necessary.

The adhesive layer 130 may be further formed to adhere to a touch screen panel, etc. and may be formed on a surface of the transparent film 110 (hereinafter, referred to as a lower surface on the basis of FIG. 1).

The adhesive layer 130 may be formed by coating directly on the lower surface of the transparent film 110. Alternatively, the adhesive layer 130 may be coated in advance on an upper surface of a release film 140, and then laminated on a lower surface of the transparent film 110.

The adhesive layer 130 that can be used in the present disclosure is well known in the art, and may include, but is not limited to, acrylic adhesive, silicone adhesive, and acid-free type of hydroxyl containing adhesive. The adhesive layer 130 may include at least one selected therefrom. For example, the acid-free type of hydroxyl containing adhesive may include a known photo-initiator, such as 2-ethylhexyl acrylate, hydroxyethyl acrylate, and benzophenone, and it may further include some additives.

The additives are to improve the properties of the adhesive, and may include, but are not limited to, a known curing accelerator, a plasticizer, a dispersant, a surfactant, an antistatic agent, a defoaming agent, and a leveling agent.

The release film 140 is located on a surface of the adhesive layer 130, and protects the adhesive layer 130.

The release film 140 that can be used in the present disclosure may include polyethylene terephthalate (PET) film or the like. More preferably, the release film 140 may be a PET film having a release force of about 10 g/inch to make it easy to release.

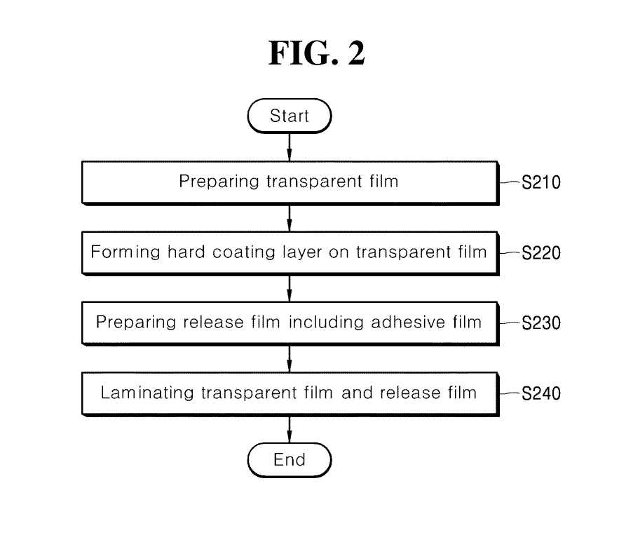

FIG. 2 is a schematic diagram showing a method for manufacturing an anti-scattering film according to an exemplary embodiment of the present disclosure.

Referring to FIG. 2, a method for manufacturing an anti-scattering film as shown in the figure will be described.

First, an anti-scattering transparent film, such as an optical PET film, having a visible light transmission of not less than 90% is prepared (S210).

Next, a hard coating solution is applied, dried and cured on a surface of the transparent film to form a hard coating layer (S220).

In this embodiment, the hard coating layer may have a pencil hardness of at least 2H, preferably 2H to 9H, such that it can complement the hardness of the transparent film.

Further, the hard coating layer may preferably have a transmittance of 90% or more, preferably 90 to 100%, a haze value of 0.8 or less, and a yellow index value of 0.8 or less, such that it can complement the optical properties of the transparent film.

For this purpose, the hard coating solution may include a solvent, and 1 to 30 parts by weight of inorganic nanoparticles, 1 to 70 parts by weight of a UV-curable acrylate resin, 1 to 15 parts by weight of a photo-initiator, and 0.2 to 5 parts by weight of azo-based dyes, with respect to 100 parts by weight of solids.

The solvent in the hard coating solution may include at least one known organic solvent, such as ketones and alcohols.

Further, the hard coating solution may include additives, where necessary, as long as maintaining its hard coating properties, such as, for example, a filler, a reinforcing agent, a flame retardant, a plasticizer, a lubricant, a stabilizer (including an antioxidant, an ultraviolet absorber, a heat stabilizer, etc.), a release agent, an antistatic agent, a surfactant, a dispersant, a flow controlling agent, a leveling agent, a defoaming agent, a surface modifier, a low-stress agent (including a silicone oil, a silicone rubber, a various plastic powder, etc.), a heat resistant modifier, and the like. These additives may be used alone or in combination with two or more thereof.

In the step of forming a hard coating layer (S220), a method for applying a hard coating solution on a surface of the transparent film may include, but is not limited to, spin coating, spray coating, casting, bar coating, roll-to-roll coating, gravure coating, dipping, and the like. Among these methods, roll-to-roll coating method is most preferred in terms of the productivity. When applying the hard coating solution having the above-defined composition, the contact angle on a surface of the hard coating layer may be 70° or less. Thereby, it is possible to suppress the delamination between the hard coating layer and the subsequent coating layer.

Next, a release film on which the adhesive layer is formed is prepared (S230).

The adhesive layer may be formed by applying, drying and curing on an upper surface of the release film, such as a release PET film having a release force of about 10 g/inch, at least one adhesive selected from acrylic adhesives, silicone adhesives, and acid-free type of hydroxyl containing adhesives.

Next, after preparing the transparent film and the release film, the release film is laminated on the transparent film such that the adhesive layer is located on a lower surface of the transparent film (S240).

In FIG. 2, when an anti-scattering film is consisted only of a transparent film and a hard coating layer, the steps of preparing a release film on which the adhesive layer is formed (S230) and laminating the release film onto the transparent film (S240) may be omitted.

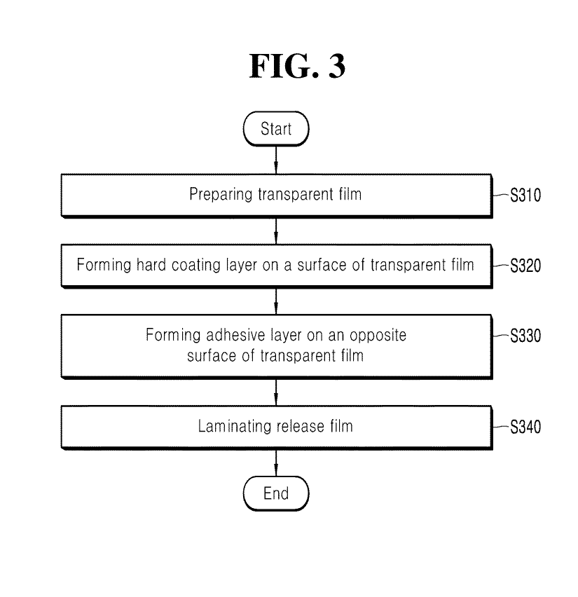

FIG. 3 is a schematic diagram showing a method for manufacturing an anti-scattering film according to other exemplary embodiment of the present disclosure.

As shown in FIG. 3, the method for manufacturing an anti-scattering film may include directly coating an adhesive layer onto a surface of a transparent film. This method will be described by referring to FIG. 3.

First, an anti-scattering transparent film, such as an optical PET film, is prepared (S310).

Next, a hard coating solution is applied, dried and cured on a surface of the transparent film to form a hard coating layer (S320).

The step of forming the hard coating layer (S320) may be conducted as the step of forming above-mentioned hard coating layer (S220), and so duplicate explanations are omitted.

Next, an adhesive layer may be formed by applying, drying and curing on an opposite surface of the transparent film, at least one or two adhesives selected from acrylic adhesives, silicone adhesives, and acid-free type of hydroxyl containing adhesives (S330).

Next, a release film is laminated to a lower surface of the adhesive layer to protect the adhesive layer (S340).

In FIG. 3, when an anti-scattering film is consisted only of a transparent film and a hard coating layer, the steps of forming the adhesive layer (S330) and laminating the release film onto the lower surface of the adhesive layer (S340) may be omitted.

As such, according to FIGS. 2 and 3, controlling a composition of the hard coating layer may contribute to make an anti-scattering film with excellent optical and scratch resistant properties while at the same time having a low delamination property with a subsequent coating layer with easy.

In addition, according to the present disclosure, it is possible to improve a blanking problem during a subsequent process by the above-described anti-scattering film and accordingly enhance process yield.

### EXAMPLE

Hereinafter, the present disclosure will be described in more detail with reference to some specific examples thereof. However, the following examples are provided for illustration only and are not to be construed as limiting the present disclosure in any way.

Description of details apparent to those skilled in the art will be omitted for clarity.

### 1. Preparation of Sample

### Example 1

An anti-scattering film comprising, from the top view, hard coating layer, optical PET film having transmittance of 92%, adhesive layer, and release film having a release force of 10 g/inch was prepared. Then, the release film was removed and the exposed anti-scattering film was laminated to a surface of touch screen panel.

In this case, hard coating solution comprising ethanol, and 20 parts by weight of inorganic nanoparticles, 30 parts by weight of UV-curable acrylate resin, 10 parts by weight of benzophenone, and 2 parts by weight of azo-based dyes represented by the following formula 1, with respect to 100 parts by weight of solids, was applied by roll-to-roll coating, and then dried and cured to form the hard coating layer having yellow index value of 1.0 or less. In addition, acrylic adhesive was used for the adhesive layer.

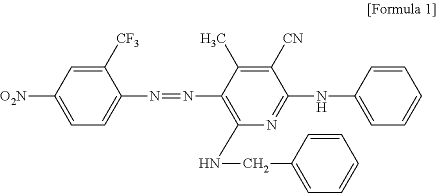 [SMILES: Cc1c(C#N)c(Nc2ccccc2)nc(NCc2ccccc2)c1N=Nc1ccc([N+](=O)[O-])cc1C(F)(F)F]

### Example 2

This example was conducted as Example 1, except that hard coating solution comprising ethanol, and 20 parts by weight of inorganic nanoparticles, 30 parts by weight of UV-curable acrylate resin, 10 parts by weight of benzophenone, and 3 parts by weight of azo-based dyes represented by formula 1, with respect to 100 parts by weight of solids, was applied by roll-to-roll coating, and then dried and cured to form the hard coating layer.

### Example 3

This example was conducted as Example 1, except that hard coating solution comprising ethanol, and 20 parts by weight of inorganic nanoparticles, 30 parts by weight of UV-curable acrylate resin, 10 parts by weight of benzophenone, and 5 parts by weight of azo-based dyes represented by formula 1, with respect to 100 parts by weight of solids, was applied by roll-to-roll coating, and then dried and cured to form the hard coating layer.

### Comparative Example 1

This example was conducted as Example 1, except that hard coating solution comprising ethanol, and 20 parts by weight of inorganic nanoparticles, 30 parts by weight of UV-curable acrylate resin, and 10 parts by weight of benzophenone, with respect to 100 parts by weight of solids, was applied by roll-to-roll coating, and then dried and cured to form the hard coating layer.

### Comparative Example 2

This example was conducted as Example 1, except that a commercially available hard coating film for anti-scattering film (3M Company, Japan) was used.

### 2. Property Evaluation

Table 1 shows the results of transmittance, haze value, yellow index value, pencil hardness, contact angle, and delamination evaluations for the anti-scattering film prepared according to Examples 1 to 3 and Comparative Examples 1 and 2.

The pencil hardness was measured in accordance with JIS K5600-5-4.

The delamination was evaluated by forming an anti-scattering hard coating layer onto an optical PET film according to Examples 1 to 3 and Comparative Examples 1 and 2, and then forming 100 cells by a crosscut using CT-24 from Nichiban Co., Ltd. to test their adherence.

Delamination Evaluation—O: good, X: bad

TABLE 1

| | Target | | | | C. | C. |
|---|---|---|---|---|---|---|
| | value | Ex. 1 | Ex. 2 | Ex. 3 | Ex. 1 | Ex. 2 |
| Transmittance | ≧90 | 91 | 91 | 91 | 91 | 91 |
| (%) | | | | | | |
| Haze | ≦0.8 | 0.26 | 0.2 | 0.76 | 0.3 | 0.84 |
| Yellow index | ≦0.8 | 0.59 | 0.55 | 0.17 | 0.64 | 0.63 |
| Pencil | ≧2H | 2H | 2H | 2H | 2H | 2H |
| hardness | | | | | | |
| Contact angle | ≦70° | 65° | 65° | 65° | 65° | 70° |
| Delamination | O | O | O | O | O | O |

As shown in Table 1, for the yellow index values, all of Examples 1 to 3 and Comparative Examples 1 and 2 met the target value requirement, and, for the haze values, all but Comparative Example 2 met the target value requirement.

In particular, Examples 1 to 3 indicates that as the content of azo-based dyes increases, the yellow index values are continuously lowered, but may, if the content thereof exceeds a certain optimal value, rather cause haziness.

In view of the foregoing, we have found that the optical properties of Examples 1 to 3 are superior to Comparative Examples 1 and 2, and especially Example 2 where the dyes were added in an appropriate amount has excellent optical properties compared to Examples 1 and 3.

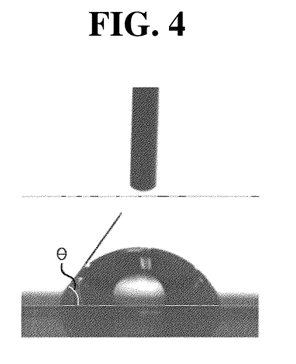

FIG. 4 is a photograph of measuring a contact angle on a surface of the hard coating layer in an anti-scattering film according to Example 1 of the present disclosure.

The photograph, as shown in FIG. 4, confirmed that the contact angle θ on the surface of the hard coating layer in the anti-scattering film according to Example 1 of the present disclosure was 65°.

Further, Table 1 and FIG. 4 demonstrates that the anti-scattering film which meets the requirements in accordance with the present disclosure is capable of suppressing the delamination with a subsequent coating layer.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the scope of the present disclosure shall be determined only according to the attached claims.

1. An anti-scattering film, comprising:
a transparent film, and
a hard coating layer formed on an upper surface of the transparent film,
wherein the hard coating layer comprises 1-30 parts by weight of inorganic nanoparticles, 1-70 parts by weight of a UV-curable acrylate resin, 1-15 parts by weight of a photo-initiator, and 0.2-5 parts by weight of azo-based dyes, with respect to 100 parts by weight of solids.

2. The anti-scattering film according to claim 1, wherein the hard coating layer has a pencil hardness of 2H to 9H.

3. The anti-scattering film according to claim 1, wherein the hard coating layer has a contact angle of 70° or less.

4. The anti-scattering film according to claim 1, wherein the hard coating layer has a transmittance of 90% to 100%.

5. The anti-scattering film according to claim 1, wherein the hard coating layer has a thickness of 1 μm to 10 μm.

6. The anti-scattering film according to claim 1, wherein the transparent film comprises at least one selected from polyethylene terephthalate (PET), polyethylene naphthalate (PEN), polyethersulfone (PES), polycarbonate (PC), polyethylene (PE), and poly propylene (PP).

7. The anti-scattering film according to claim 1, further comprising an adhesive layer formed on an opposite surface of the transparent film.

8. The anti-scattering film according to claim 7, wherein the adhesive layer comprises at least one selected from an acrylic adhesive, a silicone adhesive, and an acid-free type of hydroxyl containing adhesive.

9. A method for manufacturing an anti-scattering film, comprising: applying, drying and curing a hard coating solution onto a surface of a transparent film to form a hard coating layer, wherein the hard coating layer comprises 1-30 parts by weight of inorganic nanoparticles, 1-70 parts by weight of a UV-curable acrylate resin, 1-15 parts by weight of a photo-initiator, and 0.2-5 parts by weight of azo-based dyes, with respect to 100 parts by weight of solids.

10. The method according to claim 9, wherein the hard coating solution is applied onto a surface of the transparent film by roll-to-roll process.

11. The method according to claim 9, further comprising forming an adhesive layer onto an opposite surface of the transparent film.
